(19) United States
(12) Patent Application Publication
(10) Pub. No.: US 2015/0149252 A1
(43) Pub. Date: May 28, 2015

(54) Psychographic Analysis and Classification System

(71) Applicants: Brent Neil Walker, Cincinnati, OH (US); James Casey Albertson, Sharps Chapel, TN (US); Robert J. Freeberg, Mason, OH (US)

(72) Inventors: Brent Neil Walker, Cincinnati, OH (US); James Casey Albertson, Sharps Chapel, TN (US); Robert J. Freeberg, Mason, OH (US)

(73) Assignee: C2B SOLUTIONS, LLC, Mason, OH (US)

(21) Appl. No.: 14/090,772

(22) Filed: Nov. 26, 2013

(51) Int. Cl. G06Q 30/02

(52) U.S. Cl. CPC G06Q 30/0204
USPC 705/7.33

(57) ABSTRACT

A method for psychographically classifying a respondent based upon the respondents' health values. The method includes receiving a respondent's answers to a series of queries relating to health and analyzing the answers to determine a psychographic characteristic of the respondent. The method further includes providing information to the respondent based upon the results of the analyzing step.

The present invention is directed to a psychographic analysis and classification system, more particularly, to a psychographic analysis and system which can be used in conjunction with health and wellness profiles.

### BACKGROUND

Information is presented to individuals in a wide variety of manners, such as via the internet, mobile devices, print, advertising and by other media or forms. A challenge in assembling and presenting information to mass audiences is that each individual processes information differently, and are receptive to differing types of information and modes of delivery. Accordingly, many content providers present information in a broad, “one-size-fits-all” approach which can be acceptable to a wide class of individuals, but which can be of limited effectiveness for many individuals.

### SUMMARY

One embodiment of the present invention is a system for psychographically classifying a respondent, and providing information to the respondent in a tailored manner based upon their psychographic classification. More particularly in one embodiment the invention is a method for psychographically classifying a respondent based upon the respondents' health values. The method includes receiving a respondent's answers to a series of queries relating to health and analyzing the answers to determine a psychographic characteristic of the respondent. The method further includes providing information to the respondent based upon the results of the analyzing step.

### BRIEF DESCRIPTION OF THE DRAWING

FIG. 1 is a schematic illustration of a system which can be used to implement and execute the system and method disclosed herein.

### DETAILED DESCRIPTION

Broadly speaking, in one embodiment the system and method disclosed herein is used to psychographically classify a respondent (also termed a user herein), and to tailor content (and/or a user experience) based upon the user's psychographic classification. This methodology allows the content and/or user experience to be provided to the respondent in a manner best suited for that particular respondent.

In order to illustrate certain principles of the invention, a specific embodiment is presented which addresses psychographic classification of a user/respondent based the user's health, wellness, nutrition, medication, and related (collectively termed “health” herein) values. However, it should be understood that the system and method is not limited to use with health values, and may instead or in addition be used on conjunction with other values or psychographic qualities. In addition, it should be understood that the system and method may incorporate methodologies, structures, processes and algorithms that vary from the particular examples provided in the example set forth below.

Queries

As noted above, the first step in the process is to psychographically analyze and classify a particular user. Thus, in order to do so the user can first be presented with a questionnaire or a set of queries directed to the subject at hand (e.g. healthcare, in the illustrated embodiment). The questionnaire can be presented in a wide variety of manners and methods, but in one embodiment is presented electronically via a user interface so that the user can respond electronically. For example, in one case, the first time a user visits a website, the user may be invited, or required, or complete a psychographic questionnaire before proceeding. The user's responses to the questionnaire are then stored and/or transmitted to the system operator. Alternatively, however, rather than being presented electronically, if desired the queries can be presented in print or other analog formats, with the answers potentially being converted into digital form for processing and analysis (such as via a spreadsheet program or the like).

Each query presented to the user may be designed to gauge a particular psychographic quality. For example, in one case, the user may be presented with the question/query “I believe I can directly influence how long I will live, regardless of my family history.” This question can be utilized to gauge the level of the respondent's self-determination and pro-activeness with regard to health care. Accordingly, although this question can be asked in differing manners, and using different terminology, the objective of the associated query can remain consistent.

When the users are presented with the query, they can be presented with a number of choices to select (five choices in the illustrated embodiment), for example, “strongly agree,” “agree,” “neither agree nor disagree,” “disagree,” and “strongly disagree.” In one case, each answer can be provided with a numerical value, for example, a “strongly agree” answer may be afforded a point value of 5, “agree” a point value of 4, “neither agree nor disagree” a point value of 3, “disagree” a point value of 2, and “strongly disagree” a point value of 1.

Alternatively, rather than being provided with discrete answers and point values, in one case the user can be provided with a sliding scale (e.g., between 1 and 5) with precision carried out to one or more decimal points. Furthermore, the point values provided to each answer can, of course, vary from those disclosed above, and the number of the choices to be selected by the user can also be varied.

One example of a set of queries which can be utilized for psychographically classifying a user based upon health values, along with the associated objective for each question, is provided below.

TABLE 1

| Query | Query Objective |
|---|---|
| I believe I can directly influence how long I will live, | Gauge the level of self-determination and pro- |
| regardless of my family history | activeness of the respondent with regard to health care |
| I'm more worried about other family members' health | Determine where the respondent's energy, focus, and |
| than my own | priority are directed regarding health and wellness: |
| | inwardly (self) or externally (family). |
| I prefer alternative medicine to standard medical practice | Determine the degree to which the respondent believes |
| | health solutions lie outside mainstream medicine |
| I believe alternative/holistic/natural medicines are | Gauge respondent's belief in the effectiveness of non- |
| effective for helping maintain my health and wellbeing | mainstream medicine |
| I don't let being sick get in the way of my work | Understand the priority the respondent places on daily |
| | responsibilities versus focusing on getting better when |
| | sick; measures the likelihood the respondent will |
| | address his/her health issues |
| There are better things in life to focus on than healthy | Measure the likelihood that the respondent will |
| behavior | prioritize healthy behaviors |
| I am successful in maintaining healthy nutritional habits | Determine whether the respondent follows nutritional |
| | behaviors that are consistent with wellbeing |
| I will go to the doctor at the first sign of health concerns | Understand whether the respondent will be a high |
| | utilizer of the health system and whether health issues |
| | will be quickly addressed |
| My doctor is the most credible authority for my health | Determine whether the respondent is deferential toward |
| and wellness needs | physicians or if he/she is not as likely to take a |
| | physician's recommendations at face value |
| I actively seek information about nutrition and healthy | Understand the degree to which the respondent stays up |
| diets | to date on the latest healthy nutrition information and is |
| | likely to adopt the latest recognized, beneficial, |
| | nutrition behaviors |
| I would be willing to experience major delays in getting | Understand how the respondent prioritizes his/her |
| a doctor appointment if it meant everyone could get the | individual needs, and understand whether longer wait |
| health care they need | times will lead to greater dissatisfaction |
| I give a significant amount of money to charity | Understand an aspect of the respondent's social |
| | responsibility and whether they are motivated to help |
| | others |

The numerical answer to each query may be provided to the system directly from the user input. Alternatively, the system may convert the output provided from the user interface into a numerical value to be further processed. In any case, once the answer, or numerical equivalent, to each question is received by the system operator, the system can proceed to analyze the responses, and ultimately place each respondent in a psychographic classification. In some cases, the users can be presented with additional questions which do not carry any weight with respect to the psychographic analysis, but which could be useful for other purposes.

Categories

The user's answers to the questions are then analyzed, as will be addressed in greater detail below, to classify the user in any of a number of categories, segments or classifications. A meaningful number of respondents (e.g. at least about 1,000 in one case, or at least about 10,000 in another case, with no practical upper limit) may complete questionnaires and be classified, although the system does not necessarily have a lower limit as to the number of respondents. Each category can represent users who have a particular set of shared psychographic qualities or characteristics.

The number of categories should be sufficiently large to provide meaningful distinctions between categories, but not so large as to create undue classification, processing or implementation difficulties. Similarly, the qualities associated with each category should provide meaningful distinctions which mirror real-life qualities, and each category should represent a significant percentage of the population (e.g. not less than 10% in one case; and/or the largest category should be no more than two or three times larger than the smallest category). Of course, as a practical matter, respondents will typically not be a “perfect fit” for any one category and will likely have qualities or characteristics of more than one category. Nevertheless the system and method may classify each user in only a single category based upon the user's qualities deemed to be most relevant for the purposes at hand.

In the particular embodiment described herein, the system utilizes five psychographic categories as follows: 1) “balance seekers” who are wellness-oriented users who tend to self-treat when possible; 2) “willful endurers” who are relatively disengaged from health and wellness priorities; 3) “priority jugglers” who tend to focus more on others' health and wellbeing than their own, and/or may have so many responsibilities that they react to their own health issues only when needed; 4) “self-achievers” who are proactive and wellness-oriented individuals that engage the health care system frequently; and 5) “direction takers” who are relatively reactive to health care issues and/or place a high importance on guidance provided by health care professionals.

The number and type of psychographic categories, and psychographic qualities associated with each category, can vary depending upon the qualities to be examined, the purpose of the classification, the degree of precision required, etc. As noted above, more or less than five categories can be utilized depending upon the particular situation. In the particular application in which the five categories, with the labels as outlined above, have been developed, it has been found that the number and types of categories meet the criteria outlined above with respect to, for example, category discrimination, number of categories, balanced percentages, providing meaningful distinctions, etc.

Methodology

As outlined above, the system receives answers and/or numerical equivalents, to each question answered by the respondents. The answers are then processed using an algorithm to classify each user in one of the five psychographic categories. In one embodiment, prior to processing each user's answers, the system first stores, or has access to, a database which stores a numerical constant for each query for each of the psychographic categories. For example, Table 2 below presents a sample table numerical constant for the first three questions.

TABLE 2

| Question | Psychographic | Psychographic | Psychographic | Psychographic | Psychographic |
|---|---|---|---|---|---|
| Number | Category 1 | Category 2 | Category 3 | Category 4 | Category 5 |
| 1 | 3.2 | 0.3 | 3.4 | 4.0 | −2.0 |
| 2 | 2.1 | 3.1 | 1.6 | 0.7 | 1.0 |
| 3 | 1.1 | −0.3 | −1.2 | 1.5 | 1.5 |

It should be noted that each of the twelve questions of Table 1 would include a numerical constant for each question; Table 2 provides constants for only three questions for the sake of compactness. It should also be noted that the numerical constants shown in Table 2 are provided for illustrative purposes and are not necessarily empirically useful.

As outlined above, the respondent's answer to each query can be converted to a numerical value (between 1 and 5 in the illustrated embodiment). In one case, in order to determine a particular respondent's psychographic classification based upon the respondent's answers, the numerical constant for each query, for each category, is multiplied by the numerical value for each answer provided by the respondent. For example, if, in response to query 1, the respondent answers “strongly agree,” a numerical value of 5 would be assigned to that answer. The numerical answer is then multiplied by each numerical constant associated with that question, resulting in the running score for that respondent as shown below in Table 3.

TABLE 3

| Question | Psychographic | Psychographic | Psychographic | Psychographic | Psychographic |
|---|---|---|---|---|---|
| Number | Category 1 | Category 2 | Category 3 | Category 4 | Category 5 |
| 1 | 16.0 | 1.5 | 17.0 | 20.0 | −10.0 |

Next, if the respondent answers “disagree” (numerical value 2) to query 2 and “neither agree nor disagree” (numerical value 3) to query 3, the running tally for that respondent can be reflected as shown below in Table 4.

TABLE 4

| Question | Psychographic | Psychographic | Psychographic | Psychographic | Psychographic |
|---|---|---|---|---|---|
| Number | Category 1 | Category 2 | Category 3 | Category 4 | Category 5 |
| 1 | 16.0 | 1.5 | 17.0 | 20.0 | −10.0 |
| 2 | 4.2 | 6.2 | 3.2 | 1.4 | 2.0 |
| 3 | 3.3 | −0.9 | −3.6 | 4.5 | 4.5 |

As outlined above, the numerical value for each query is multiplied by the associated numerical constant to result in the values shown above. However, if desired, other mathematical operations, besides or in addition to, multiplication, may be utilized (e.g. the numerical value for each query can be divided by the associated numerical constant, in which case the value for the numerical constant would need to be adjusted, etc.).

Each category can also include an adjustment constant associated therewith. The adjustment constant can be used for determining the respondent's total score for classification purposes, and will vary as desired for calibration purposes. One example of the adjustment constant is included in Table 5 below.

TABLE 5

| Question | Psychographic | Psychographic | Psychographic | Psychographic | Psychographic |
|---|---|---|---|---|---|
| Number | Category 1 | Category 2 | Category 3 | Category 4 | Category 5 |
| 1 | 16.0 | 1.5 | 17.0 | 20.0 | −10.0 |
| 2 | 4.2 | 6.2 | 3.2 | 1.4 | 2.0 |
| 3 | 3.3 | −0.9 | −3.6 | 4.5 | 4.5 |
| Adjustment | 2.1 | 3.0 | 4.3 | 4.5 | 5.5 |
| Constant | | | | | |

The numerical values, including the adjustment constant (if utilized) in Table 5 are then summed to provide a total for that respondent in each category, as shown in Table 6 below.

TABLE 6

| Question | Psychographic | Psychographic | Psychographic | Psychographic | Psychographic |
|---|---|---|---|---|---|
| Number | Category 1 | Category 2 | Category 3 | Category 4 | Category 5 |
| 1 | 16.0 | 1.5 | 17.0 | 20.0 | −10.0 |
| 2 | 4.2 | 6.2 | 3.2 | 1.4 | 2.0 |
| 3 | 3.3 | −0.9 | −3.6 | 4.5 | 4.5 |
| Adjustment | 2.1 | 3.0 | 4.3 | 4.5 | 5.5 |
| Constant | | | | | |
| Total | 25.6 | 9.8 | 20.9 | 30.4 | 2.0 |

The category having the highest value (in this case, Psychographic Category 4) can then be assigned to the respondent. Thus, the algorithm for classifying each respondent can be implemented utilizing the following algorithm:

For each iεN calculate:

$${α}_{k} + {\sum }_{j = 1}^{J} {x}_{ij} {β}_{jk} = {Σ}_{ik} , \\ ∀ k ∈ K$$

where,
αₖ is the segment specific constant (adjustment constant),
xᵢⱼ is respondent i's response to question j, and
βⱼₖ is the segment specific coefficient (numerical constant) for question j.
Then for each respondent choose,

$${k}^{*} st {Σ}_{{ik}^{*}} = {max}_{K} \{ {Σ}_{ik} \}$$

and k* is the category to which respondent i should be assigned.

Of course, as mentioned above it should be understood Tables 2-6 illustrate an abbreviated set of calculated of the illustrated embodiment outlined above, which actually uses twelve questions and can use different numerical constants and adjustment constants than those shown herein. In addition, any of a wide variety of other algorithms or the like can be utilized to psychographically classify the respondent, and the system and method disclosed herein is not necessarily limited to the specific algorithm shown herein.

Optimization

Each of the queries presented to a respondent (such as the queries set forth in Table 1) seeks to determine, gauge or ascertain the respondent's beliefs, values, behaviors, attitudes, personality, motivation and other psychographic factors with respect to the subject (e. g. health care) at hand. The questions/queries utilized to classify each user should be engineered to provide accurate classification of the users in an efficient manner (i.e. with as few questions as possible). In the example provided herein, it has been found that the use of twelve particular questions provides a relatively minimum number of questions that can be used to classify each user in one of the five categories with a high level of confidence. In particular, the system disclosed herein has been found to be 91.1% accurate in properly classifying a respondent (greater than 90% can be particularly useful), which is believed to be quite high considering the relatively low number of questions (twelve) compared to the number of segments (five) (a ratio of 2.4:1; a ratio of less than 3:1 may be particularly desirable). The queries can be carefully selected and worded so that the users can be properly psychographically classified with few questions (to reduce the burden on the respondent) and with high accuracy.

In order to arrive at twelve particular questions set forth in Table 1, 106 initial questions were created, tested and analyzed with respect to their ability to differentiate consumers on a variety of considerations including their health care, engagement in healthy activities, attitude towards their physicians, attitude towards the health care industry, attitudes towards health care reform, belief in the efficiency of over the counter drugs, and other factors. The selected questions should meet four criteria: 1) providing the most differentiation between segments; 2) producing segments that are internally consistent; 3) providing actionable market insights; and 4) creating results that are stable and reproducible. A factor analysis, using statistical clustering procedures and linear discriminate analysis, was conducted to examine response patterns to the various questions.

In the case of the questions of Table 1, it has been found that use of each of the twelve questions can be utilized to provide the analysis herein and meet the criteria set forth above. It has been found that the removal of even a single of the twelve questions, in this particular embodiment, can result in less-than-satisfactory predictions.

Implementation

Once the user is psychographically classified, the classification data can be associated with each user, and stored. The classification data can then be utilized to present content to the user in a targeted manner and/or to the customize user experience. The content can take the form of information, education, marketing or communication provided to a user. The content can be delivered in a variety of manners, such as on a website, in mailings and print materials, webinars, video presentations, etc., and can be adjusted or selected based upon the user's psychographic category. In addition, the user interface and/or the manner in which information is presented, such as look, interaction and/or user interface of a website, can also be modified. Since psychographic classification provides information regarding the respondent's motivations, targeting messages and experiences on this basis (as opposed to, for example, demographic, socioeconomic, or claims data) can be particularly effective.

Continuing with the example set forth herein, if a respondent is classified as a “willful endurer,” it may be concluded that the respondent is relatively disengaged from health and wellness priorities. In this case, then, information may be presented and/or the user interface arranged in a manner which seeks to engage the respondent. In contrast, if the respondent is categorized as a “priority juggler” then information may be presented and/or the user interface modified to emphasize the ability to complete tasks quickly and easily, since “priority jugglers” may have limited time.

In this manner, the psychographic categorization can be used to understand the respondent's motivations, predict consumer health and wellness attitudes and behaviors, identify the most effective methods for influencing positive health behaviors, and help health care providers (e.g. physicians, hospitals and health insurance companies) to improve the delivery of health care. In some cases, hospitals, accountable care organizations (“ACOs”) and health insurance companies can have their reimbursement partially tied to consumer experience measures and re-admittance rates. The use of the system and method disclosed herein can help those organizations to deliver a customer-preferred experience and/or to motivate patients to adhere to their health care provider's recommendations, thereby improving the rate of reimbursement to the organizations. Thus, the consumer categorization/segmentation model helps to create consumer-defined experiences and deliver improved medical outcomes based upon psychographic classification, and helps to provide information in a manner most effective for influencing positive health behaviors.

While some health care organizations may employ consumer segmentation, the segregation is often limited to demographic (gender, age, ethnicity, etc.), socio-economic (income, insurance coverage, ability to pay), or medical claims-based segmentation (i.e. segmenting by prescription use, hospitalizations, labs, and other behaviorally based variables). However, these segmentation methods group individuals according to physical behavior or situational characteristics, and do not measure patient motivation. In contrast, the segmentation model disclosed herein enables health care providers (and others) to customize their approach to different users based upon the user's beliefs, values and motivations. It has been found that the use of psychographic segmentation, to address the motivation of why consumers behave in certain ways, can be more effective than use of other segmentation. As noted above, it should be understood that the system and method is not limited to use with health values of a user, and may instead or in addition be used on conjunction with other psychographic qualities, such as user attitudes with respect to investment and financial matters, purchasing behaviors, political activities, personal behavior, etc.

Implementation System

Due to the high volume of data needing to be tracked, screened and applied, and the various calculations required to be carried out, the system and method disclosed herein can be largely computer-implemented. For example, a computer can be used to set up the questionnaire, track the answers, convert the answer to numerical values, multiply each number by the associated numerical constant, add the values and the adjustment constant, and ultimately classify each user.

As used herein “computer” means a desktop computer, laptop computer, mobile device, tablet, tablet computer or computer processor combined with supporting elements (real or virtualized) such as hardware, firmware, and memory supporting software in execution. One or more computers can reside in or on a server in various embodiments and the server can itself be comprised of multiple computers. One or more computers can reside within a process and/or thread of execution, and a computer can be localized at one location and/or distributed between two or more locations.

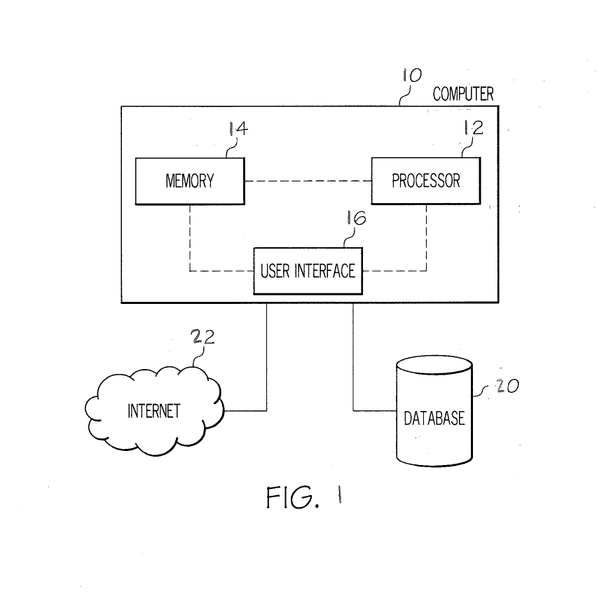

As shown in FIG. 1, a computer 10 can include a processor 12, a memory 14, and a user interface 16 (which can take the form of, for example, a touch screen, keyboard, mouse or other cursor control device, other input devices, screen/monitor, printer, etc.) to receive inputs from, and provide outputs to, a user. The computer 10 can be operatively coupled to a database 20 which stores information relating to the questions, answers, numerical values, adjustment constants, categories, and/or algorithms. As used herein “database” means any of a number of different data stores that provide searchable indices for storing, locating and retrieving data, including without limitation, relational databases, associative databases, hierarchical databases, object-oriented databases, network model databases, dictionaries, flat file/XML datastores, flat file systems with spidering or semantic indexing, and the like. The data may be stored in persistent storage such as hard disk drives or non-volatile memory. Alternately, or in addition, the same information can be stored in the random access memory of the computer 10, and thus also be considered a database.

Moreover, such information, including but not limited to the questions, answers, numerical values, adjustment constants, categories and/or algorithms can be manipulated by software stored in the memory 14 and/or the processor 12. The software may be able to be read/executed/acted upon by the processor 12. As used herein, “software” means one or more computer readable and/or executable instructions or programs that cause a computer to perform functions, actions and/or behave in a desired manner. The instructions may be embodied in various forms such as routines, algorithms, modules, methods, threads, and/or programs. Software may also be implemented in a variety of executable and/or loadable forms including, but not limited to, stand-alone programs, function calls (local and/or remote), servelets, applets, instructions stored in a memory, part of an operating system or browser, bytecode, interpreted scripts and the like. It should be appreciated that the computer readable and/or executable instructions can be located on one computer and/or distributed between two or more communicating, co-operating, and/or parallel processing computers or the like and thus can be loaded and/or executed in serial, parallel, massively parallel and other manners. It should also be appreciated that the form of software may be dependent on various factors, such as the requirements of a desired application, the environment in which it runs, and/or the desires of a particular designer/programmer. The software may be stored on a tangible medium, such as memory, on a hard disk drive, on a compact disc, flash drive, etc.

The computer may also be connected to the internet 22, as shown in FIG. 1, to receive inputs and provide outputs. The computer 10 can communicate with the internet 22 or other computers via computer communications. For the purposes of this application “computer communications” means communication between two or more computers or electronic devices, and can take the form of, for example, a network transfer, a file transfer, an applet transfer, an email, a hypertext transfer protocol (HTTP) message, a datagram, an object transfer, a binary large object (BLOB) transfer, and so on. Computer communication can occur across a variety of mediums by a variety of protocols, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, and various other systems.

The various functions described above may each be provided or contained in their own module. For example, the system may utilize a question-presenting module for presenting questions to the user; an answer-receiving module for receiving answers and/or assigning numerical value to answers; a calculating module for calculating a user's score and/or assigning the user to a category; and a customization module for providing content and/or a user experience. Each module can be a block of software, code, instructions or the like which, when executed by the computer 10, provide the desired functions. Each module may be able to interact with the other modules, and may not necessarily be discrete and separate from the other modules, the user interface, or other components of the system. The modules in the system may be functionally and/or physically separated, but can share data, outputs, inputs, or the like to operate as a single system and provide the functions described herein.

The present invention has been described herein with regard to certain embodiments. However, it will be obvious to persons skilled in the art that a number of variations and modifications can be made without departing from the scope of the invention as described herein.

What is claimed is:

1. A method for psychographically classifying a respondent based upon the respondents' health values comprising:
receiving a respondent's answers to a series of queries relating to health;
analyzing the answers to determine a psychographic characteristic of the respondent; and
providing information to the respondent based upon the results of the analyzing step.

2. The method of claim 1 wherein the analyzing step includes classifying the respondent into one of a plurality of psychographic categories.

3. The method of claim 2 wherein the content of the information in the providing step, or the manner in which the information is provided in the providing step, or both, varies depending upon the classification of the respondent.

4. The method of claim 2 wherein the analyzing step includes classifying the respondent into one of five psychographic categories.

5. The method of claim 2 wherein the psychographic categories include a balance seekers category that includes respondents who are wellness-oriented and/or favor self-treatment; a willful endurer category that includes respondents who are relatively disengaged from health priorities; a priority juggler category that includes respondents that focus more on others' health than their own; a self-achiever category that includes respondents who are proactive and/or wellness-oriented; and a direction taker category that includes respondents who are relatively reactive to health issues and/or place high importance on guidance provided by health care professionals.

6. The method of claim 2 wherein the respondent is classified into said psychographic categories solely based upon ascertained psychographic qualities of the respondent.

7. The method of claim 2 wherein the method includes receiving or storing a numerical constant for each query for each of the psychographic categories, and wherein the analyzing step includes assigning or receiving a numerical value to each answer provided by the respondent and multiplying each numerical value by the associated numerical constant for the associated query.

8. The method of claim 7 wherein the analyzing step further includes summing the multiplied values for each of the psychographic categories for a given respondent, adding an adjustment constant to each summed multiplied values, and classifying the respondent into a psychographic category based upon the adjusted summed values.

9. The method of claim 2 wherein the method is repeated for a meaningful population of respondents, and wherein the system provides over 90% accuracy in properly classifying respondents.

10. The method of claim 2 wherein a total number of said queries is less than three times larger than a total number of said categories.

11. The method of claim 2 wherein the method is repeated for a meaningful population of respondents, and wherein the categories are relatively even such that the number of respondents included in the largest category is no more than three times larger than the number of respondents in the smallest category.

12. The method of claim 1 wherein the providing step includes at least one of providing advertising to the respondent or presenting a website for use by the respondent.

13. The method of claim 1 wherein said series of queries includes: 1) a query configured to determine the respondent's level of self-determination and/or pro-activeness regarding health care; 2) a query configured to determine whether the respondent's focus for health is directed toward the respondent himself/herself or externally toward others; 3) a query configured to determine the degree to which the respondent believes health solutions lie outside mainstream medicine; 4) a query configured to determine the respondent's belief in the effectiveness of non-mainstream medicine; 5) a query configured to determine the priority the respondent places on getting better when sick and/or the likelihood the respondent will address his or her health issues; 6) a query configured to determine the likelihood that the respondent will prioritize healthy behaviors; 7) a query configured to determine whether the respondent practices healthy nutritional behaviors; 8) a query configured to determine whether the respondent will be a high utilizer of a professional health care services and/or health issues will be quickly addressed; 9) a query configured to determine the respondent's deference toward physicians; 10) a query configured to determine whether the respondent stays up to date on the latest healthy nutrition information and/or is likely to adopt the latest recommended nutritional behaviors; 11) a query configured to determine the how respondents prioritizes his or her individual needs and/or to extent to which longer waiting times lead to greater dissatisfaction; and 12) a query configured to determine the respondent's social responsibility and/or motivation to help others.

14. A method for classifying a respondent in a psychographic category comprising:
presenting a set of queries to a respondent, the queries including: 1) a query configured to determine the respondent's level of self-determination and/or pro-activeness regarding health care; 2) a query configured to determine whether the respondent's focus for health is directed toward the respondent himself/herself or externally toward others; 3) a query configured to determine the degree to which the respondent believes health solutions lie outside mainstream medicine; 4) a query configured to determine the respondent's belief in the effectiveness of non-mainstream medicine; 5) a query configured to determine the priority the respondent places on getting better when sick and/or the likelihood the respondent will address his or her health issues; 6) a query configured to determine the likelihood that the respondent will prioritize healthy behaviors; 7) a query configured to determine whether the respondent practices healthy nutritional behaviors; 8) a query configured to determine whether the respondent will be a high utilizer of a professional health care services and/or health issues will be quickly addressed; 9) a query configured to determine the respondent's deference toward physicians; 10) a query configured to determine whether the respondent stays up to date on the latest healthy nutrition information and/or is likely to adopt the latest recommended nutritional behaviors; 11) a query configured to determine the how respondents prioritizes his or her individual needs and/or to extent to which longer waiting times lead to greater dissatisfaction; and 12) a query configured to determine the respondent's social responsibility and/or motivation to help others;
analyzing the answers to the queries; and
classifying the respondent in a psychographic category based upon an output of the analyzing step.

15. The method of claim 14 wherein the analyzing step includes classifying the respondent into one of a plurality of psychographic categories, and wherein the method further includes providing information to the respondent, and wherein the content of the information in the providing step, or the manner in which the information is provided in the providing step, or both, varies depending upon the classification of the respondent.

16. The method of claim 14 wherein the method includes receiving or storing a numerical constant for each query for each psychographic category, and wherein the analyzing step includes assigning or receiving a numerical value to each answer provided by the respondent and multiplying each numerical value by the associated numerical constant for the associated query.

17. A method for classifying a respondent in a psychographic category comprising:
receiving a respondent's answers to a series of queries;
assigning or receiving a numerical value to each answer;
multiplying each numerical value by a numerical constant associated with each psychographic category for each query;
summing the multiplied values for each of the psychographic categories for a given respondent; and
classifying the respondent in a psychographic category based upon the summed values.

18. The method of claim 17 further comprising the step of adding an adjustment constant to each summed value, and wherein the classifying is based upon the adjusted summed value.

19. The method of claim 17 wherein each numerical constant is different for each psychographic category for a given query.

20. The method of claim 17 wherein the classifying step includes psychographically classifying a respondent based upon the respondents' values with respect to health, and wherein the method further includes providing information to the respondent based upon the results of the analyzing step.
